(19) United States
(12) Patent Application Publication
(10) Pub. No.: US 2003/0168846 A1
(43) Pub. Date: Sep. 11, 2003

(54) Total reinforcement device for the filing of folder sheets

(76) Inventor: Ricardo Lebedevski, Buenos Aires (AR)

Correspondence Address: Ronald Abramson, Hughes Hubbard & Reed LLP, One Battery Park Plaza, New York, NY, 10004-1482, US

(21) Appl. No.: 09/950,929

(22) Filed: Sep. 12, 2001

(30) Foreign Application Priority Data
Sep. 12, 2000 (AR) M010101153

(51) Int. Cl. B42D 1/00; B42D 19/00; B42D 5/00

(52) U.S. Cl. 281/38; 281/2; 281/5

(57) ABSTRACT

A reinforcement device to be incorporated to punched folder sheets which increases paper resistance around the punched areas of the folder sheet and reduces their deterioration. In one embodiment, a reinforcement strip is added during the manufacturing process so as to reinforce the area of the punched hole. The reinforcement strip may be added before or after punching the holes, and may be a continuous or non-continuous strip. The reinforcement device may be used with a variety of paper sizes or weights, and may be made of a variety of materials, for example, polyurefin, PVC film or polyamide.

This utility model relates to stationery articles in general and especially to a complete reinforcement device to be incorporated to punched folder sheets for school, student and business uses.

The main purpose of this utility model is to provide a simple and practical device of the above-mentioned type, which increases paper resistance around the punched areas of the folder sheets and facilitates their orderly presentation or filing into folders or other elements so as to reduce their deterioration by permanent manipulation.

This utility model is thus aimed at providing a device of attractive and economic construction which ensures an appropriate conservation of the sheets in their folders as the punches made in the original paper or cardboard sheets remain indefinitely in good condition in spite of mistreatment or the frequent placement and removal of rings or other fastening means provided with the folders.

It is obvious that such a really simple system ensures at all times an appropriate presentation of any worksheets, annotations, homework, drawings, tables, etc., of the type that usually requires the use of loose sheets with side punches to permit their conservation in folders, loose covers, filing devices and the like.

### PREPARATION

The preparation of the system contemplates the use of sheets of different sizes, with or without lines, of the various qualities of paper which are commonly used for manual or typed writing or drawing. These sheets can be found at stationery shops, either as loose units, or in packages of different quantities, or even bound so as to be preserved in good condition for use at any time. These sheets may then be used for performing any homework, writing exercises, maps, drawings or paintings made by schoolchildren or students of secondary or tertiary level, and also for office worksheets made by hand or machine. All such work is then saved into folders or covers specially prepared for such use. These elements are equipped with fastening devices such as broken rings with fast opening and closing mechanisms, pass-through screws, metal strips which pass through circular, oval or square holes and are applied on the sheets, either lengthwise or crosswise, and then bent against a metal channel to be secured by sliding pieces or other similar devices.

It is common to observe a marked deterioration of the punched holes due to careless manipulation, especially by schoolchildren and students of all ages and levels, which usually results in the need to make a second hole close to the previous one, which of course changes the alignment of the sheets. In an effort to solve this problem there appeared in due course a variety of sticky cardboard washers to be applied to the broken holes. A later improvement were the washers made of a cloth-type material.

It is in order to provide a new and definitive solution to this problem, which could be implemented in an easy, economic and attractive form, that this utility model is proposed, as it offers an optimum constructive arrangement. It basically consists of a reinforcement strip to be incorporated during the manufacturing process of the sheet, regardless of its quality or size.

This utility model uses conventional paper sheets, such as the so-called “repuestos” or spare sheets, to which a strip is applied consisting of a thin thermoplastic material film which covers the punched hole rim. The strip may be applied continuously or by sections.

In order to facilitate the understanding of this utility model consisting of a reinforcement device for punched folder sheets, and to ensure that it can be easily implemented, we will offer below a precise description of a preferred way of implementation based on the enclosed drawings, as an example for purposes of mere demonstration but without any limitation, whose components may be selected from among various equivalents without deflecting from the principles of the model as described in this documentation.

### BRIEF DESCRIPTION OF THE DRAWINGS

According to the figures attached to this technical and legal description:

FIG. 1 is a schematic perspective view of the utility model components. These are conveniently separated according to one possible constructive implementation.

FIG. 2 is a schematic plant view of the reinforcement strip which is part of the utility model.

FIG. 3 is a schematic view of an original vertical spare sheet.

FIG. 4 is a schematic view of the new sheet that is obtained.

FIG. 5 is a schematic view of a variation of the reinforcement strip.

FIG. 6 shows the new oblong sheet obtained.

In the above figures, the same characters make reference to the same or corresponding parts.

### DESCRIPTION

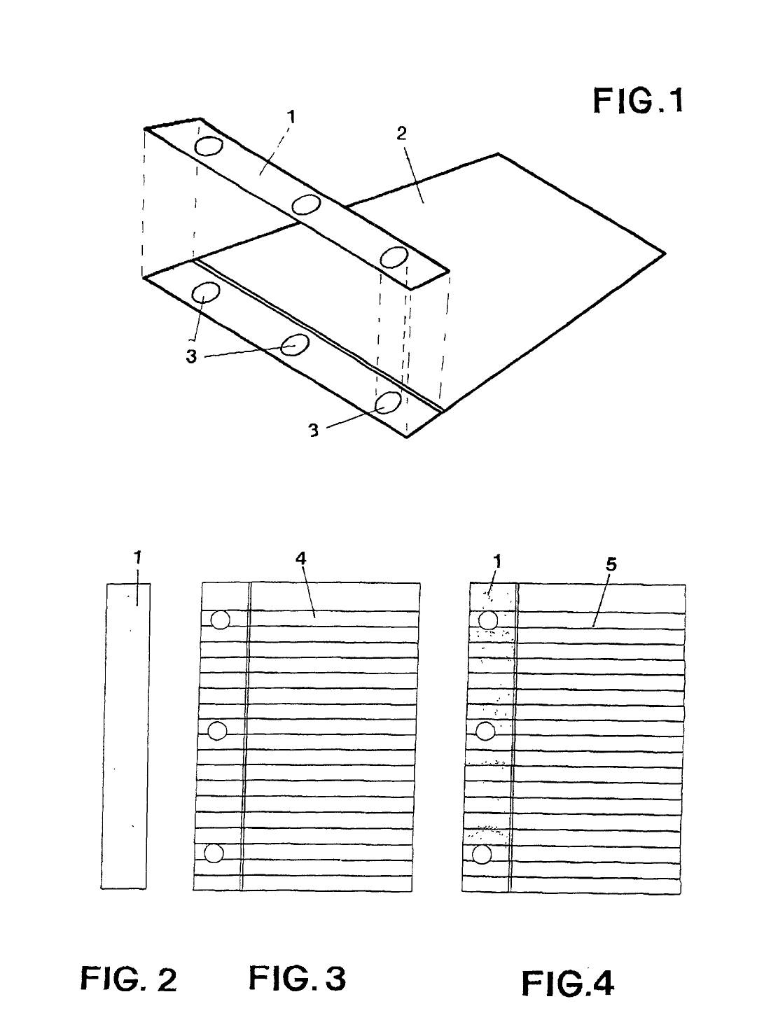

FIG. 1 illustrates the reinforcement strip -1-, at a distance from the original sheet -2-, to which it is applied during this stage of the manufacturing process; the punched holes -3- are also visible.

FIG. 2 shows the reinforcement strip -1- in plant view, next to which FIG. 3 shows a conventional spare sheet with lines -4-.

FIG. 4 is the result of incorporating the strip -1- to the sheet -4-, which results in the model sheet designated as -5-.

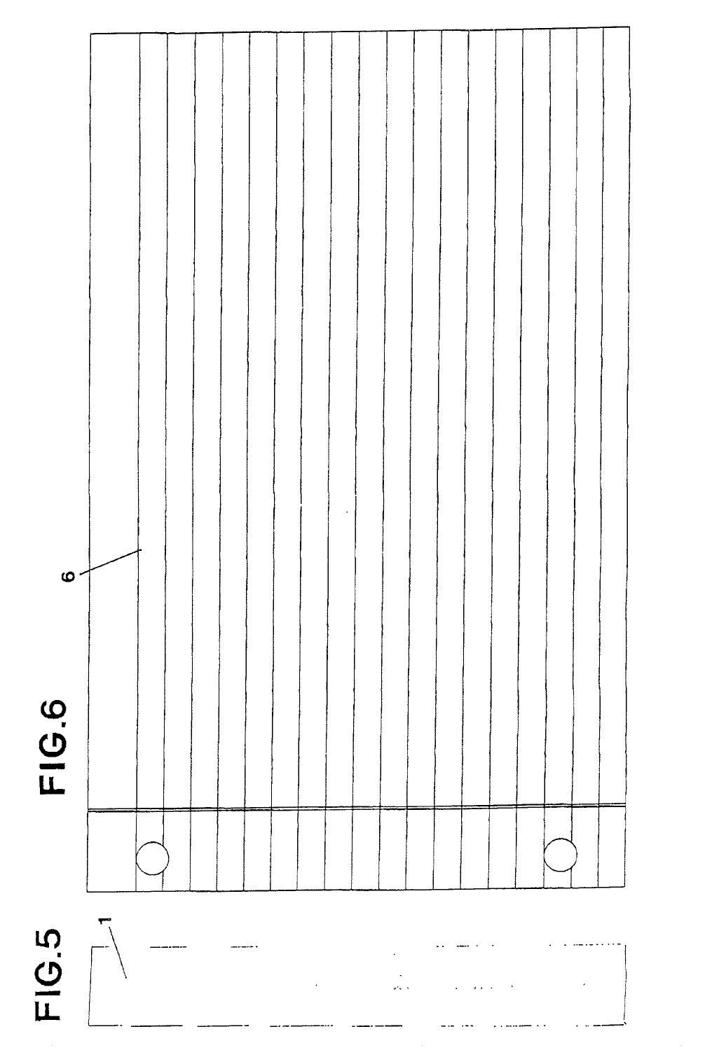

FIG. 5 shows the strip -1- ready for being stuck to the conventional oblong sheet -6-.

Although the components appear in the figures with their holes already punched, it must be noted that the strips may be applied without any holes so that these can be made at a later stage. The essence of the final utility model is that it has the strip stuck to it as illustrated by FIG. 5. A possible variation not illustrated here might consist of discontinuous plastic strip stretches located in coincidence with the required holes.

In order to obtain the described result, conventional paper sheets are used, either plain or with lines, and either bound or loose. Their weight may range from at least 50 grams/m² to 140 grams/m² in all formats including A6, A5, A4, A3 and even 320×470 mm. On one side of the sheet circular, oval or square holes are made, either lengthwise or crosswise, of a size comprised within 3 to 10 mm of diameter or side of the hole.

The protection strip -4- is incorporated by stretches or continuously as illustrated, during the manufacturing process of the sheets. It includes a thin, resistant sheet element, either transparent or colored, consisting of a thermoplastic strip of a material such as polyurefin or PVC film or even polyamide of a thickness between 15 and 50 microns, and a width between 4 and 70 mm.

The thermoplastic material is applied in solid state, then melted at a controlled temperature and is automatically applied to the paper. After this it is subject to fast cooling to ensure that it will stick to the supporting element.

This strip may also be presented in textured form or with images, information, symbols, etc.

The final product will have all the characteristics of the “original base product” with the operational improvement provided by the incorporation of the above-mentioned strip during the manufacturing process.

### PERFORMANCE

Once the different components of the utility model version have been determined as indicated above in order to explain their nature, the description will be completed below with reference to the functional and operational relationship between its different parts and the results obtained.

Given the morphologic and constructive simplicity of the utility model described above, it seems unnecessary to go into any further details. It is crystal clear that this new industrial product provides countless advantages as regards its operational performance from the viewpoint of users, without this involving a noticeable increase in manufacturing costs.

The above has attempted to summarize one of the various constructive possibilities inherent in the utility model and the manner in which it operates, and it is now the time to supplement this description with the replevin clauses attached below:

After having described and determined the nature of the utility model, its scope and the manner in which it can be basically implemented, exclusive property rights must now be asserted as regards the following. I claim:

1. Complete reinforcement device for punched folder sheets, applicable to paper sheets with holes made on one of their sides, be they of vertical or oblong format, plain or with lines, of different sizes, qualities and weights, supplied loose or in parcels as spare sheets, characterized as consisting of a thin thermoplastic material strip stuck to the paper, either continuously or by stretches, on the side of the sheet which has the holes, such strip to consist of a film with a thickness comprised between 15 and 50 microns.

2. Complete reinforcement device for punched folder sheets according to replevin 1, characterized as one in which the said thermoplastic strip consists of a polyurefin or PVC film.

3. Complete reinforcement device for punched folder sheets according to replevin 1 and 2, characterized as one in which the said thermoplastic strip consists of a polyamide film.

4. Complete reinforcement device for punched folder sheets according to replevins 1 to 3, characterized as one in which the said thermoplastic strip is firmly incorporated to the paper and sticks to it by melting at a controlled temperature followed by fast cooling.

5. Complete reinforcement device for punched folder sheets according to replevin 1, characterized as one in which the said thermoplastic strip may be made of a transparent, colored or textured material.

6. Complete reinforcement device for punched folder sheets according to replevin 1, characterized as one in which the said thermoplastic strip ranges within a width preferably comprised between 4 and 70 mm.
